(19) United States
(12) Patent Application Publication
(10) Pub. No.: US 2006/0025076 A1
(43) Pub. Date: Feb. 2, 2006

(54) Method and apparatus for transmitting and receiving bluetooth data

(76) Inventor: Wei-Wen Yu, Keelung City (TW)

Correspondence Address: RABIN & Berdo, PC, 1101 14TH STREET, NW, SUITE 500, WASHINGTON, DC, 20005, US

(21) Appl. No.: 11/168,528

(22) Filed: Jun. 29, 2005

(30) Foreign Application Priority Data
Jul. 27, 2004 (TW) 93122466

(51) Int. Cl. H04B 7/00

(52) U.S. Cl. 455/41.2

(57) ABSTRACT

A method and apparatus applied to a host, for transmitting a Bluetooth data via a portable apparatus having a Bluetooth module, includes steps of: (a). the host choosing “transmit mode”; (b). setting the portable apparatus as “Bluetooth mode”; (c). the host generating a Bluetooth command and the Bluetooth data; (d). the host transmitting the Bluetooth command and the Bluetooth data to the portable apparatus; (e). the portable apparatus receiving the Bluetooth command and the Bluetooth data and generating a wireless data according thereto; and (f). the portable apparatus outputting the wireless data and receiving and transmitting other Bluetooth data to the host.

This application claims the benefit of Taiwan Application Serial No. 093122466, filed Jul. 27, 2004, the subject matter of which is incorporated herein by reference.

### BACKGROUND OF THE INVENTION

1. Field of the Invention

The invention relates in general to a method and an apparatus for transmitting and receiving Bluetooth data, and more particularly to a method and an apparatus for transmitting and receiving Bluetooth data via a portable apparatus.

2. Description of the Related Art

With the increasing demands of wireless application in short distance, wireless communication has been an important parts of modern office equipments. One of essential part of a network technology is Bluetooth. Because Bluetooth can easily go through any external matters to transmit data in short distance with one-to-many spots and is not limited to any particular directions, Bluetooth is popularly applied to various wireless communication apparatuses, such as notebooks, mobile phones, digital cameras, printer, projectors, hands free earphone, for transmitting data like electrical files or voices.

However, although mobile phones having Bluetooth function have been available in the market generally, it is not seen in personal computers (PCs). Conventionally, it is necessary to buy and install an additional Bluetooth dongle in the PC so that the PC can transmit or receive blue data via the Bluetooth dongle.

### SUMMARY OF THE INVENTION

In view of the foregoing, it is an object of the present invention to provide an apparatus and a method for transmitting/receiving a Bluetooth data in a computer system capable of using the built-in Bluetooth module of mobile phones or personal digital assistances (PDAs) to transmit/receive the Bluetooth data rather than using an additional Bluetooth dongle. This invention can be applied to a host by combining with a portable apparatus having a Bluetooth module, such as mobile phones, PDAs. Bluetooth modules have been considered as basic equipments of the portable apparatuses nowadays, whereby it won't be necessary for users to buy any other produces so that the cost can be saved.

The invention achieves the above-identified object by providing a method for transmitting a Bluetooth data via a portable apparatus having a Bluetooth module and being applied to a host, comprising steps of: (a). the host choosing “transmit mode”; (b). setting the portable apparatus as “Bluetooth mode”; (c). the host generating a Bluetooth command and the Bluetooth data; (d). the host transmitting the Bluetooth command and the Bluetooth data to the portable apparatus; (e). the portable apparatus receiving the Bluetooth command and the Bluetooth data and generating a wireless data according thereto; and (f). the portable apparatus outputting the wireless data.

It is another object of the invention to provide a method for receiving a Bluetooth data via a portable apparatus having a Bluetooth module and being applied to a host, comprising steps of: (a). the host choosing “transmit mode”; (b). setting the portable apparatus as “Bluetooth mode”; (c). the Bluetooth module receiving a wireless data and generating a Bluetooth data according thereto; (d). the portable apparatus outputting the Bluetooth data to the host; and (e). the host receiving the Bluetooth data.

It is another object of the invention to provide an apparatus for transmitting data including a host and a portable apparatus. The host has a CPU for choosing “transmit mode”, a profile module, connected with the CPU, for generating a Bluetooth command and the Bluetooth data and an I/O port host, connected with the CPU and the profile module, for receiving the Bluetooth command and transmitting the Bluetooth data according thereto. The portable apparatus has an I/O port client, connected with the I/O port host, for receiving the Bluetooth command and transmitting the Bluetooth data according thereto, a processor, connected with the I/O port client, for receiving the Bluetooth command, setting the portable apparatus as “Bluetooth mode”, and transmitting the Bluetooth data, and a Bluetooth module, connected with the processor, for receiving the Bluetooth data, generating a wireless data according thereto and outputting the wireless data.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of an apparatus for transmitting Bluetooth data according to the preferred embodiment of the present invention.

FIG. 2 is a flow chart showing a method for transmitting Bluetooth data according to the preferred embodiment of the present invention.

FIG. 3 is a flow chart showing a method for receiving Bluetooth data according to the preferred embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like components throughout.

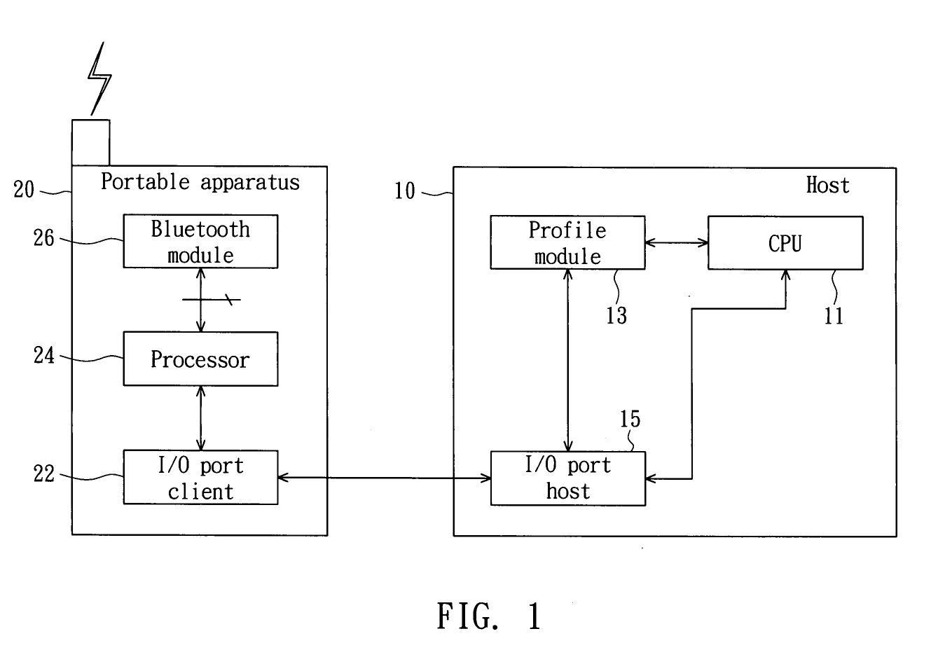

Referring to FIG. 1, which is a block diagram of an apparatus for transmitting Bluetooth data according to the preferred embodiment of the present invention. An apparatus for transmitting data including a host 10 and a portable apparatus 20. The host 10 has a CPU 11, a profile module 13, and an I/O port host 15. The portable apparatus 20 has an I/O port client 22, a processor 24, and a Bluetooth module 26. In the host 10, the CPU 11 is used for choosing “transmit mode”, and the profile module 13, connected with the CPU 11, is used for generating a Bluetooth command and the Bluetooth data. The I/O port host 15, connected with the CPU 11 and the profile module 13, is used for receiving the Bluetooth command and transmitting the Bluetooth data according thereto. In the portable apparatus 20, the I/O port client 22, connected with the I/O port host 15, is used or receiving the Bluetooth command generated from the host 10 and transmitting the Bluetooth data according thereto. The processor 24, connected with the I/O port client 22, receives the Bluetooth command, sets the portable apparatus 20 as “Bluetooth mode”, so that the portable apparatus 20 can receive and transmit to the host 10. The Bluetooth module 26, connected with the processor 24, is used for receiving the Bluetooth data, generating a wireless data according thereto and outputting the wireless data. Also, the Bluetooth module 26 receives other wireless data from other peripheral apparatuses, generates a wireless data according thereto and outputs the wireless data to the host 10.

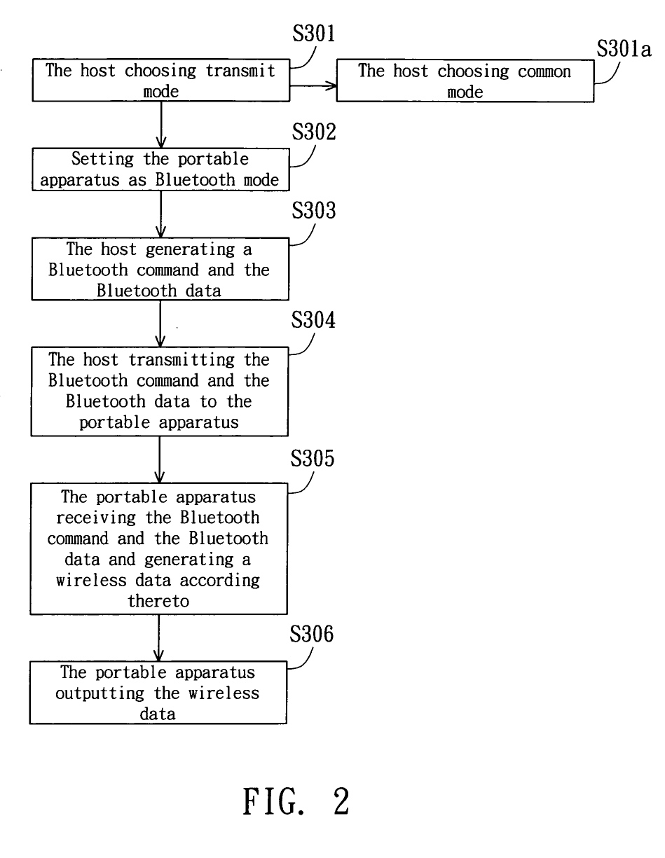

Referring to FIG. 2, it is a flow chart showing a method for transmitting Bluetooth data according to the preferred embodiment of the present invention. The method for transmitting a Bluetooth data is applied to the host 10 and the Bluetooth data is transmitted via a portable apparatus 20 having a Bluetooth module 26. The method includes steps as follow. Firstly, in step S301, the host 10 chooses “transmit mode” and sends a command to the portable apparatus 20. Alternately, in step S301a, The host 10 chooses “common mode”, the portable apparatus 20 is set as “common mode” according thereto, and the I/O port client 22 of the portable apparatus 20 transmits data for general files. Next, in step S302, the host 10 chooses “Bluetooth mode”, then the portable apparatus 20 is set as “Bluetooth mode”, and the I/O port client 22 transmits the Bluetooth data.

Further, in step S303, the profile module 13 of the host 10 generates a Bluetooth command and the Bluetooth data, and in step S304, the host 10 transmits the Bluetooth command and the Bluetooth data to the processor 24 of the portable apparatus 20. The processor 24 transmits the Bluetooth data to the Bluetooth module 26 via an interface, such as a universal asynchronous receiver/transmitter (UART) interface. Next, in step S305, the Bluetooth module 26 receives the Bluetooth data and generates a wireless data according thereto. Finally, the Bluetooth module 26 outputs the wireless data via an antenna. Here, the Bluetooth command generated by the profile module 13 should conform to host controller interface (HCI) specification.

Moreover, as described in step S304, it is via an I/O port that the host 10 transmits the Bluetooth command and the Bluetooth data to the portable apparatus 20. The I/O port could conform to RS-232 interface specification, IEEE 1394 interface specification, or universal serial bus (USB) interface specification.

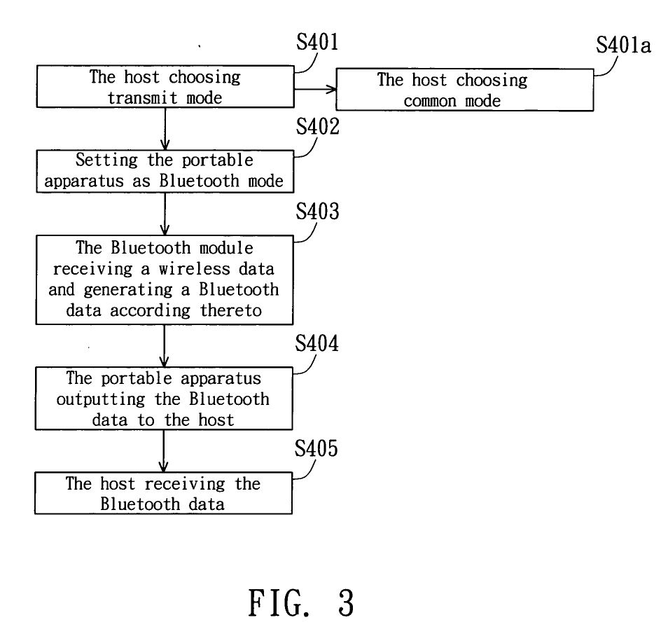

Referring to FIG. 3, it is a flow chart showing a method for receiving Bluetooth data according to the preferred embodiment of the present invention. The method for receiving a Bluetooth data is applied to the host 10 and the Bluetooth data is received via a portable apparatus 20 having the Bluetooth module 26. The method includes steps as follow. Firstly, in step S401, the host 10 chooses “transmit mode” and makes a command to the portable apparatus 20. Alternately, in step S401a, The host 10 chooses “common mode”, the portable apparatus 20 is set as “common mode” according thereto, and the I/O port client 22 of the portable apparatus 20 transmits data for general files. Next, in step S402, the host 10 chooses “Bluetooth mode”, then the portable apparatus 20 is set as “Bluetooth mode”, and the I/O port client 22 transmits the Bluetooth data.

Further, in step S403, the Bluetooth module 26 of the portable apparatus 20 receives the wireless data via the antenna and generates the Bluetooth data according thereto. Next, in step S404, the Bluetooth module 26 transmits the Bluetooth data to the processor 24 via an interface, such as a universal asynchronous receiver/transmitter (UART) interface. The processor 24 then transmits the Bluetooth data to the host 10 via the I/O port. Finally, the I/O port host 15 of the host receives the Bluetooth data. Here, the portable apparatus 20 is set as “Bluetooth mode” according to the Bluetooth command which is generated by the profile module 13. Also, the Bluetooth command should conform to host controller interface (HCI) specification.

Moreover, it is via an I/O port that the host 10 transmits the Bluetooth command and the Bluetooth data to the portable apparatus 20. The I/O port could conform to RS-232 interface specification, IEEE 1394 interface specification, or universal serial bus (USB) interface specification.

As described hereinbefore, the method for transmitting/receiving a Bluetooth of the present invention has advantages like fast transmitting speed, low cost, and availably to all. Also, because the interface specification used in the preferred embodiment is USB interface, which has the greatest transmission capacity in the market, data can be transmitted with high speed and lots of time can be saved. Further, Bluetooth modules have been considered as basic equipments of the portable apparatuses nowadays, whereby it won't be necessary for users to buy any other produces but wireless communication is simply achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for transmitting a Bluetooth data via a portable apparatus having a Bluetooth module and being applied to a host, comprising steps of:
the host choosing “transmit mode”;
setting the portable apparatus as “Bluetooth mode”;
the host generating a Bluetooth command and the Bluetooth data;
the host transmitting the Bluetooth command and the Bluetooth data to the portable apparatus;
the portable apparatus receiving the Bluetooth command and the Bluetooth data and generating a wireless data according thereto; and
the portable apparatus outputting the wireless data.

2. The method according to claim 1, wherein the host transmits the Bluetooth command to the portable apparatus via an I/O port.

3. The method according to claim 2, wherein the I/O port conforms to RS-232 interface specification.

4. The method according to claim 2, wherein the I/O port conforms to IEEE 1394 interface specification.

5. The method according to claim 2, wherein the I/O port conforms to universal serial bus (USB) interface specification.

6. The method according to claim 1, wherein the portable apparatus further comprises a processor associated with the Bluetooth module transmitting the Bluetooth data via an interface of universal asynchronous receiver/transmitter (UART).

7. The method according to claim 1, wherein the Bluetooth command conforms to host controller interface (HCI) specification.

8. A method for receiving a Bluetooth data via a portable apparatus having a Bluetooth module and being applied to a host, comprising steps of:
the host choosing “transmit mode”;
setting the portable apparatus as “Bluetooth mode”;
the Bluetooth module receiving a wireless data and generating a Bluetooth data according thereto;
the portable apparatus outputting the Bluetooth data to the host; and
the host receiving the Bluetooth data.

9. The method according to claim 8, wherein the portable apparatus outputs the Bluetooth data to the host via an I/O port.

10. The method according to claim 9, wherein the I/O port conforms to RS-232 interface specification.

11. The method according to claim 9, wherein the I/O port conforms to IEEE 1394 interface specification.

12. The method according to claim 9, wherein the I/O port conforms to universal serial bus (USB) interface specification.

13. The method according to claim 8, wherein the portable apparatus further comprises a processor associated with the Bluetooth module transmitting the Bluetooth data via an interface of universal asynchronous receiver/transmitter (UART).

14. The method according to claim 8, wherein the Bluetooth data conforms to host controller interface (HCI) specification.

15. An apparatus for transmitting data, comprising:
a host, comprising:
a CPU, for choosing “transmit mode”;
a profile module, connected with the CPU, for generating a Bluetooth command and the Bluetooth data; and
an I/O port host, connected with the CPU and the profile module, for receiving the Bluetooth command and transmitting the Bluetooth data according thereto; and
a portable apparatus, comprising:
an I/O port client, connected with the I/O port host, for receiving the Bluetooth command and transmitting the Bluetooth data according thereto;
a processor, connected with the I/O port client, for receiving the Bluetooth command, setting the portable apparatus as “Bluetooth mode”, and transmitting the Bluetooth data; and
a Bluetooth module, connected with the processor, for receiving the Bluetooth data, generating a wireless data according thereto and outputting the wireless data.

16. The apparatus according to claim 15, wherein the I/O port conforms to RS-232 interface specification.

17. The apparatus according to claim 15, wherein the I/O port conforms to IEEE 1394 interface specification.

18. The apparatus according to claim 15, wherein the I/O port conforms to universal serial bus (USB) interface specification.

19. The apparatus according to claim 15, wherein the processor and the Bluetooth module transmit the Bluetooth data via an interface of universal asynchronous receiver/transmitter (UART).

20. The apparatus according to claim 15, wherein the Bluetooth data conforms to host controller interface (HCI) specification.
